(19) United States
(12) Patent Application Publication
(10) Pub. No.: US 2021/0232958 A1
(43) Pub. Date: Jul. 29, 2021

(54) NON-TRANSITORY COMPUTER-READABLE STORAGE MEDIUM, PROCESSING INFORMATION METHOD, AND INFORMATION PROCESSING APPARATUS

(71) Applicant: FUJITSU LIMITED, Kawasaki-shi (JP)

(72) Inventors: Jumpei Yamaguchi, Kawasaki (JP); Toshiya Shimizu, Kawasaki (JP); Ryuichi Ohori, Kawasaki (JP)

(73) Assignee: FUJITSU LIMITED, Kawasaki-shi (JP)

(21) Appl. No.: 17/154,892

(22) Filed: Jan. 21, 2021

(30) Foreign Application Priority Data
Jan. 27, 2020 (JP) 2020-010913

(51) Int. Cl. G06N 7/00; G06N 10/00

(52) U.S. Cl. CPC G06N 7/005; G06N 10/00

(57) ABSTRACT

A non-transitory computer-readable storage medium storing a program that causes a processor included in a computer to execute a process, the process includes calculating, by using a tolerance being predetermined and information on a Hamiltonian, a half adjust position with which an error of the Hamiltonian between a numerical value of the Hamiltonian before approximation of the Hamiltonian and the numerical value of the Hamiltonian after the approximation of the Hamiltonian is smaller than or equal to the tolerance, and performing integerization on the numerical value of the Hamiltonian based on the half adjust position.

### CROSS-REFERENCE TO RELATED APPLICATION

This application is based upon and claims the benefit of priority of the prior Japanese Patent Application No. 2020-10913, filed on Jan. 27, 2020, the entire contents of which are incorporated herein by reference.

### FIELD

The embodiments discussed herein are related to a non-transitory computer-readable storage medium, a processing information method, and an information processing apparatus.

### BACKGROUND

Recently, an annealing calculation device has been utilized. This annealing calculation device performs annealing calculation for searching for an optimal solution by giving an initial point to a Hamiltonian and thermally oscillating the Hamiltonian. Since the annealing calculation device aims to minimize an integer Hamiltonian, when a Hamiltonian is a real number value, a conversion process including approximation and integerization is performed so that the Hamiltonian becomes an integer value.

For example, in the approximation, the real number value is subjected to half adjust (namely rounding or rounding off) in the k-th decimal place, and in the integerization, real number value having undergone the half adjust is multiplied by 10^{k-1}, thereby the real number value is converted into an integer. When the value of k is small, a deviation (error) increases and optimal solutions are not coincident with each other before and after conversion. Thus, for reduction of the deviation, k is set sufficiently large within restricting conditions of the annealing calculation device. As known annealing calculation devices, for example, there are a calculation device in which k is set to 2 to make the integer value of the Hamiltonian fall within 2⁵ and a calculation device in which k is set to 18 to make the integer value of the Hamiltonian fall within 2⁶⁴.

Related techniques are disclosed in for example International Publication Pamphlet No. 2018/190064 and Japanese Laid-open Patent Publication No. 2018-117208

### SUMMARY

According to an aspect of the embodiments, a non-transitory computer-readable storage medium storing a program that causes a processor included in a computer to execute a process, the process includes calculating, by using a tolerance being predetermined and information on a Hamiltonian, a half adjust position with which an error of the Hamiltonian between a numerical value of the Hamiltonian before approximation of the Hamiltonian and the numerical value of the Hamiltonian after the approximation of the Hamiltonian is smaller than or equal to the tolerance, and performing integerization on the numerical value of the Hamiltonian based on the half adjust position.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an information processing apparatus according to a first embodiment.

FIG. 2 is a diagram illustrating a usual conversion process.

FIG. 3 is a diagram illustrating a problem with the usual conversion process.

FIG. 4 is a functional block diagram illustrating a functional configuration of the information processing apparatus according to the first embodiment.

FIG. 5 is a diagram illustrating a specific example of integerization.

FIG. 6 is a flowchart illustrating a flow of a conversion process.

FIG. 7 is a diagram illustrating an example of a hardware configuration.

### DESCRIPTION OF EMBODIMENTS

In the related art, calculation accuracy of the minimum value of the Hamiltonian may be degraded. For example, when the integer value of the Hamiltonian is large, undulation of the function of the Hamiltonian increases, and a local solution rather than an optimal solution is likely to be reached. This reduces efficiency of calculation of the optimal solution. In contrast, when the integer value of the Hamiltonian is small, the difference between the real number value before the conversion and the integer value after the conversion increases. This reduces the reliability of the optimal solution to be obtained.

In an aspect, an information processing program, a method of processing information, and an information processing apparatus that may accurately calculate a Hamiltonian are provided.

Hereinafter, embodiments of an information processing program, a method of processing information, and an information processing apparatus disclosed herein will be described in detail based on the drawings. These embodiments do not limit the present invention. The embodiments may be combined with each other as appropriate within the technical scope without contradiction.

### First Embodiment

[Description of Information Processing Apparatus]

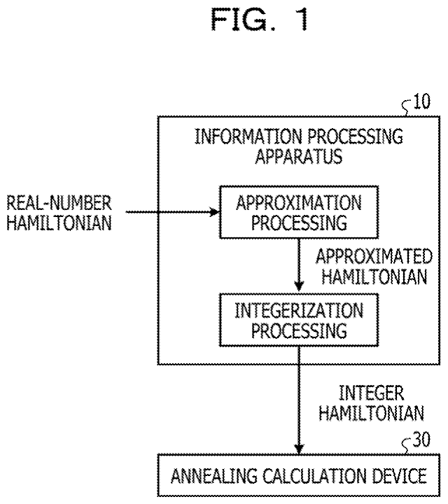

FIG. 1 is a diagram illustrating an information processing apparatus 10 according to a first embodiment. The information processing apparatus 10 illustrated in FIG. 1 converts a real number value into an integer value to perform a real-number Hamiltonian by an annealing calculation device. For example, as illustrated in FIG. 1, when a real-number Hamiltonian is input, the information processing apparatus 10 generates approximation processing to generate an approximated Hamiltonian. Then, the information processing apparatus 10 generates an integer Hamiltonian by performing integerization processing on the approximated Hamiltonian.

Then, the information processing apparatus 10 outputs the integerized Hamiltonian to an annealing calculation device 30. Consequently, the annealing calculation device 30 may perform annealing calculation on the integer Hamiltonian to calculate an optimal solution.

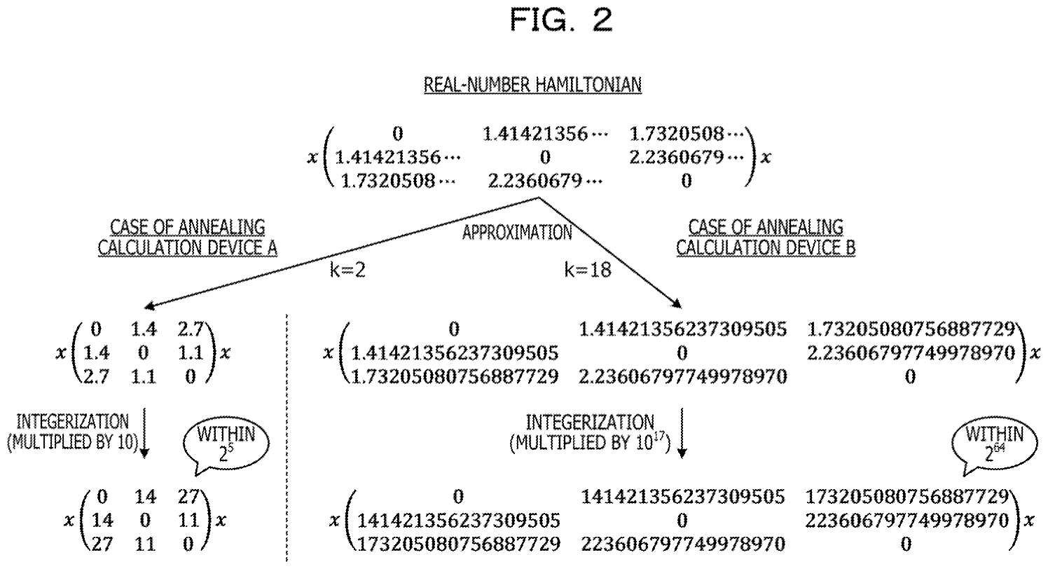

Usual conversion process that converts a real-number Hamiltonian into an integer Hamiltonian is described. FIG. 2 is a diagram illustrating a usual conversion process. Here, k represents a digit number for half adjust, and two annealing calculation devices A and B having different restricting conditions are used for description.

As illustrated in FIG. 2, for the annealing calculation device A, the integer value of a Hamiltonian is restricted to be within 2⁵. Thus, the integerization is performed after the approximation in which the decimal place is the second decimal place (k=2) has been performed. For the annealing calculation device B, the integer value of a Hamiltonian is restricted to be within 2⁶⁴. Thus, the integerization is performed after the approximation in which the decimal place is the 18th decimal place (k=18) has been performed.

When k is excessively small, a deviation before and after the conversion increases, and optimal solutions for the annealing calculation device before and after the conversion are not coincident with each other. This reduces reliability. In contrast, when k is excessively large, the integer value excessively increases, and calculation for the optimal solution becomes inefficient.

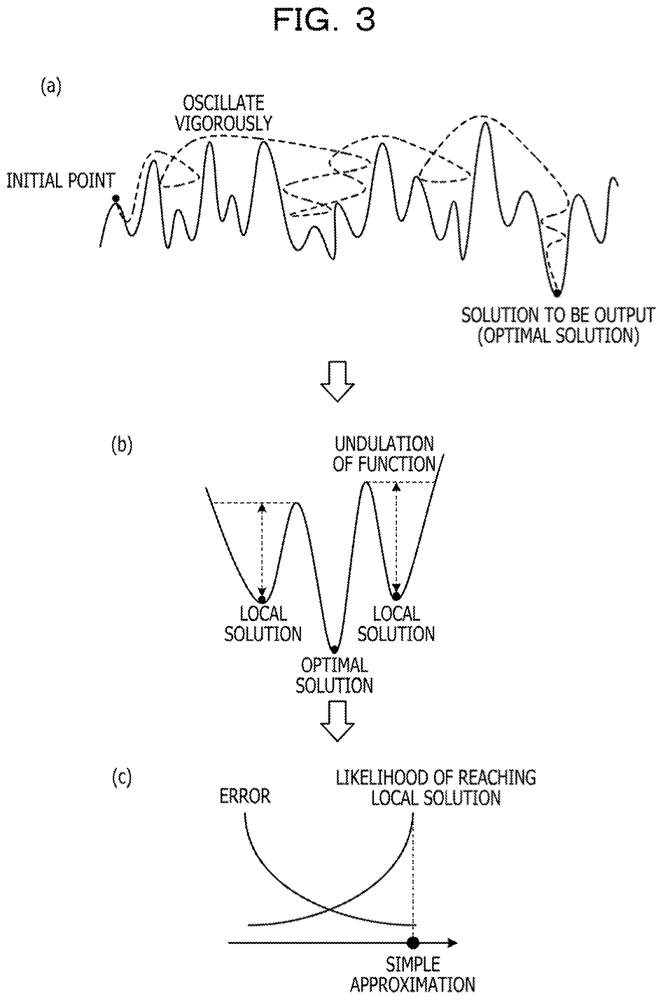

FIG. 3 is a diagram illustrating a problem of the usual conversion process. As illustrated in FIG. 3, in the annealing calculation, an initial point is given to the Hamiltonian, and the Hamiltonian is thermally oscillated to search for an optimal solution ((a) of FIG. 3). However, as illustrated in (b) of FIG. 3, when the integer value of the Hamiltonian is large, undulation of the function increases, and a local solution may be reached before the optimal solution is reached. This makes the calculation of the optimal solution inefficient. For example, as illustrated (c) of FIG. 3, there is a trade-off relationship between the likelihood of reaching a local solution and an error before and after the conversion. For this reason, in the usual conversion process, k is set to be sufficiently large within the restricting condition of the annealing calculation device to reduce the error, and accordingly, the calculation for the optimal solution becomes inefficient.

The information processing apparatus 10 according to the first embodiment improves the efficiency of the optimization calculation by performing the annealing calculation using an integerized Hamiltonian with the error accepted by utilizing the fact that the optimal solution does not vary even when a certain degree of an approximation error is accepted depending on a problem. For example, the information processing apparatus 10 according to the first embodiment suppresses an excessive increase in the integer value of the Hamiltonian and reduces the likelihood of reaching a local solution, thereby realizing improvement in the efficiency of the optimal solution.

[Functional Configuration]

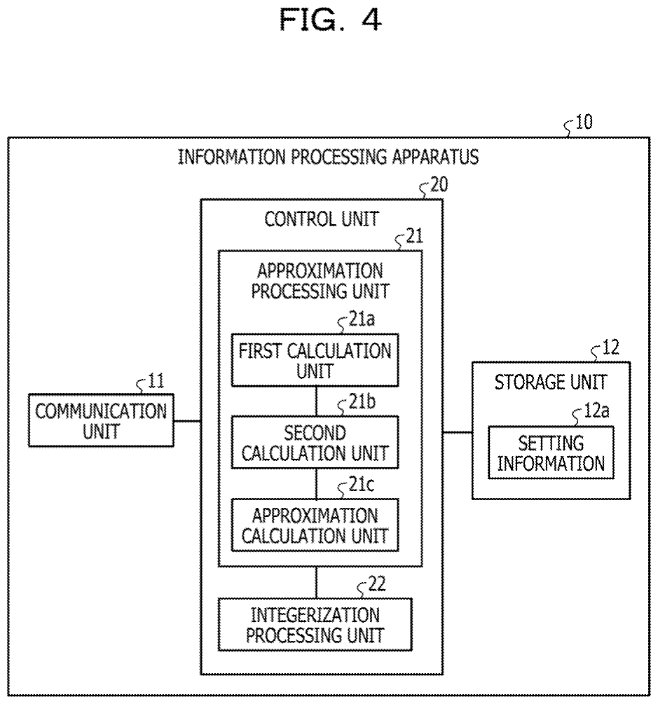

FIG. 4 is a functional block diagram illustrating a functional configuration of the information processing apparatus 10 according to the first embodiment. As the annealing calculation device 30, any of various calculation devices that perform annealing calculation on an integer Hamiltonian may be adopted.

As illustrated in FIG. 4, the information processing apparatus 10 includes a communication unit 11, a storage unit 12, and a control unit 20. The communication unit 11 is a processing unit that controls communication with other apparatuses and is, for example, a communication interface or the like. For example, the communication unit 11 receives a real-number Hamiltonian from a terminal of an administrator or the like. The communication unit 11 transmits the integer Hamiltonian generated by the control unit 20 to the annealing calculation device 30.

The storage unit 12 is an example of a storage device that stores various types of data and programs to be executed by the control unit 20, and is, for example, a memory, a hard disk, or the like. The storage unit 12 stores setting information 12a. In the setting information 12a, tolerances (T) set by the user and the like are defined. The tolerances (T) may be defined for optimization target problems on a problem-by-problem basis.

The control unit 20 is a processing unit that manages the entire information processing apparatus 10 and is, for example, a processor or the like. The control unit 20 includes an approximation processing unit 21 and an integerization processing unit 22. The approximation processing unit 21 and the integerization processing unit 22 exemplify, for example, electronic circuits included in the processor or a process performed by the processor.

The approximation processing unit 21 includes a first calculation unit 21a, a second calculation unit 21b, and an approximation calculation unit 21c. The approximation processing unit 21 is a processing unit that performs approximation by performing half adjust on a real number value of the Hamiltonian in a k-th decimal place.

The first calculation unit 21a is a processing unit that calculates a maximum value of a half adjust position (k) that falls within an input limitation of the annealing calculation device 30. For example, when the real-number Hamiltonian is represented by “H=xWx+bx+c” and a limitation of the integer to be input to the annealing calculation device 30 is “M”, the first calculation unit 21a calculates k with which the half adjust position is maximized by using Expression (1). In addition, the first calculation unit 21a calculates the calculated result to the approximation calculation unit 21c.

$$\begin{matrix}[ Expression 1 ] & \\ k = ⌊ {log}_{10} \frac{M}{max \{ \vert {w}_{i , j} \vert , \vert {b}_{i} \vert \}} ⌋ + 1 & ( 1 )\end{matrix}$$

The second calculation unit 21b is a processing unit that calculates a half adjust position with which an error of the Hamiltonian before and after the approximation is less than or equal to a tolerance. When described with reference to the above example, in the case where the tolerance is “T” and the number of variables of the Hamiltonian is “n”, the second calculation unit 21b calculates a half adjust position “I” by using Expression (2). In addition, the second calculation unit 21b calculates the calculated result to the approximation calculation unit 21c.

$$\begin{matrix}[ Expression 2 ] & \\ ℓ ← ⌈ {log}_{10} \frac{5 n ( n + 1 )}{T} ⌉ & ( 2 )\end{matrix}$$

The approximation calculation unit 21c is a processing unit that determines a half adjust position for integerization of a real number value and calculates an approximate value of the real number value. When described with reference to the above example, the approximation calculation unit 21c compares the half adjust position “k” input from the first calculation unit 21a with the half adjust position “I” input from the second calculation unit 21b so as to select the minimum value as a new “k”. Then, the approximation calculation unit 21c performs half adjust on the real number value of the Hamiltonian in the k-th decimal place to generate an approximated Hamiltonian and outputs the approximated Hamiltonian to the integerization processing unit 22.

For example, the approximation calculation unit 21c performs half adjust by using Expression (3) on a real number value “w_{i,j}” being an element of the Hamiltonian that falls within 1≤i, j≤n. Also, the approximation calculation unit 21c performs half adjust by using Expression (4) on a real number value “b” being an element of the Hamiltonian that falls within 1≤i≤n. In Expressions (3) and (4), “( )ₖ” means that the half adjust is performed in the k-th decimal place.

[Expression 3]

w_{i,j}←(w_{i,j})ₖ (3)

[Expression 4]

bᵢ←(bᵢ)ₖ (4)

The integerization processing unit 22 is a processing unit that performs integerization on a numerical value of the Hamiltonian approximated by the approximation processing unit 21. When described with reference to the above example, the integerization processing unit 22 performs integerization on “w_{i,j}” being a numerical value of the approximated Hamiltonian that falls within 1≤i, j≤n by using Expression (5). The integerization processing unit 22 performs integerization on “bᵢ” being a numerical value of the approximated Hamiltonian that falls within 1≤i≤n by using Expression (6). The integerization processing unit 22 outputs an integer Hamiltonian “H=xWx+bx+c” having been integerized as described above to the annealing calculation device 30.

[Expression 5]

w_{i,j}←10^{k-1}w_{i,j} (5)

[Expression 6]

bᵢ←10^{k-1}bᵢ (6)

### Specific Example

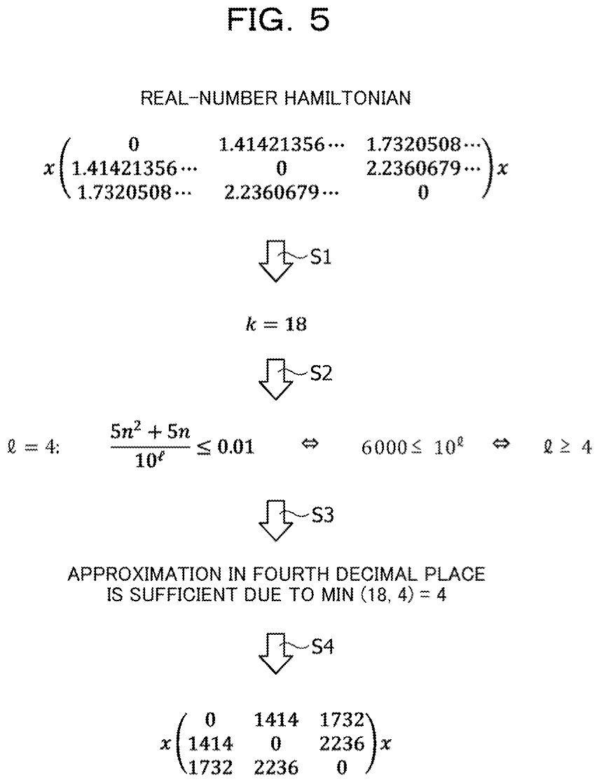

Next, a specific example of integerization of a real-number Hamiltonian will be described with reference to FIG. 5. FIG. 5 is a diagram illustrating a specific example of the integerization. For ease of understanding of the description, the Hamiltonian is simplified. A real-number Hamiltonian of three rows by three columns illustrated in FIG. 5 is taken as an example. In the description of this example, the tolerance is set to “T=0.01” and a restriction of the digit number of the integer value of the annealing calculation device 30 is set to “M=2⁶⁴”.

Elements of the real-number Hamiltonian “w_{i,j}” illustrated as the example here are as follows: “w_{1,1}=0”, “w_{2,1}=1.41421356 . . . ”, “w_{3,1}=1.7320508 . . . ”, “w_{1,2}=1.41421356 . . . ”, “w_{2,2}=0”, “w_{3,2}=2.2360679 . . . ”, “w_{1,3}=1.7320508 . . . ”, “w_{2,3}=2.2360679 . . . ”, and “w_{3,3}=0”.

In the state as described above, the approximation processing unit 21 calculates a maximum half adjust position of “k=18” by using the restriction of “M=2⁶⁴” and Expression (1) (S1). Next, the approximation processing unit 21 calculates a half adjust position “I=4” by using the tolerance “T=0.01”, “n=3”, and Expression (2) (S2). Then, the approximation processing unit 21 compares “k=18” with “I=4”, determines the minimum value “I=4” as a new “k”, and determines that a four-digit approximation is sufficient.

Consequently, the integerization processing unit 22 performs the integerization and the half adjust on the fourth digits on each of the elements “w_{i,j}” of the real-number Hamiltonian so as to convert the real number values into the integer values (S4). For example, the integerization processing unit 22 performs the conversion into the following elements “w_{i,j}” of the real-number Hamiltonian: “w_{1,1}=0”, “w_{2,1}=1414”, “w_{3,1}=1732”, “w_{1,2}=1414”, “w_{2,2}=0”, “w_{3,2}=2236”, “w_{1,3}=1732”, “w_{2,3}=2236”, and “w_{3,3}=0”.

[Flow of Process]

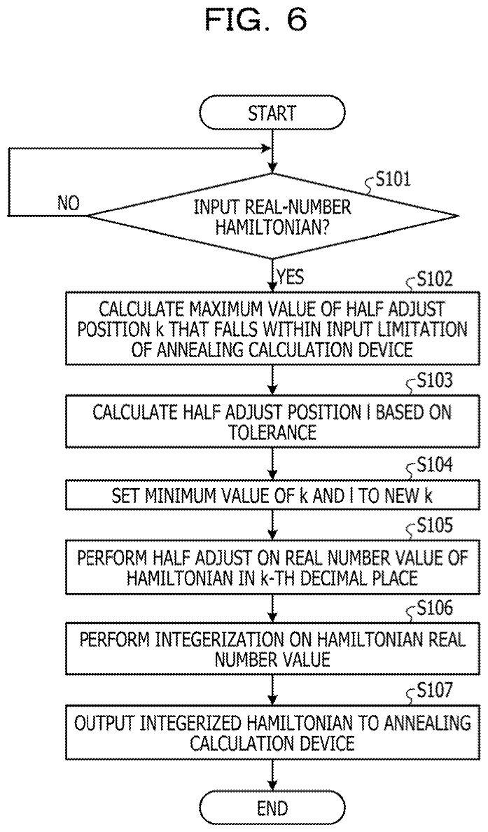

FIG. 6 is a flowchart illustrating a flow of conversion process. As illustrated in FIG. 6, when a real-number Hamiltonian is input (S101: Yes), the approximation processing unit 21 calculates the maximum value of the half adjust position “k” that falls within the input limitation of the annealing calculation device 30 (S102).

Then, the approximation processing unit 21 calculates the half adjust position “I” with which an error between the Hamiltonian before and after approximation is less than or equal to the tolerance (S103). Then, the approximation processing unit 21 newly sets the minimum value of “k” and “I” to “k” (S104).

Then, the integerization processing unit 22 performs the half adjust on the real number value of the Hamiltonian in the k-th decimal place by using the newly set “k” (S105). Then, the integerization processing unit 22 performs the integerization on the real number value of the approximated Hamiltonian (S106) and outputs the integerized Hamiltonian to the annealing calculation device 30 (S107).

[Effects]

As described above, the information processing apparatus 10 may determine the digit number for half adjust so that the error caused by the conversion is within the tolerance given on a problem-by-problem basis. As a result, the information processing apparatus 10 may suppress an excessive increase in the integer value of the Hamiltonian and reduce the likelihood of reaching a local solution, thereby improving the efficiency of optimization calculation of the annealing calculation device.

### Second Embodiment

While the embodiment of the present invention has been described, the present invention may be implemented in various different forms other than the above-described embodiment.

[Numerical Values or the Like]

The examples of the numerical values, the numerical values of the Hamiltonian, forms, and the like used in the above-described embodiment are merely examples and may be arbitrarily changed. The information processing apparatus 10 and the annealing calculation device 30 may be implemented in the same housing.

[Setting of k]

The example in which the maximum value of k is calculated by Expression (1) is described according to the above-described embodiment, this is not limiting. For example, setting by the user within the restriction of the annealing calculation device 30 may be allowed. It may also be allowed to determine the final half adjust position by using only the half adjust position “I” with which the error of the Hamiltonian before and after the approximation is less than or equal to the tolerance without using the half adjust position “k” that falls within the input limitation of the annealing calculation device 30.

[System]

Unless otherwise specified, processing procedures, control procedures, specific names, and information including various types of data and parameters described in the above description or illustrated in the drawings may be arbitrarily changed.

The elements of the illustrated apparatus are of functional concepts, and the apparatus is not necessarily physically configured as illustrated in the drawings. For example, the specific form of distribution or integration of the apparatus is not limited to those illustrated in the drawings. For example, the entirety or part of the apparatus may be configured so as to be functionally or physically distributed or integrated in an arbitrary unit in accordance with various types of load, usage states, or the like.

All or an arbitrary subset of the processing functions performed by the apparatus may be realized by a central processing unit (CPU) and programs to be analyzed and executed by the CPU or may be realized by a hardware apparatus using wired logic.

[Hardware]

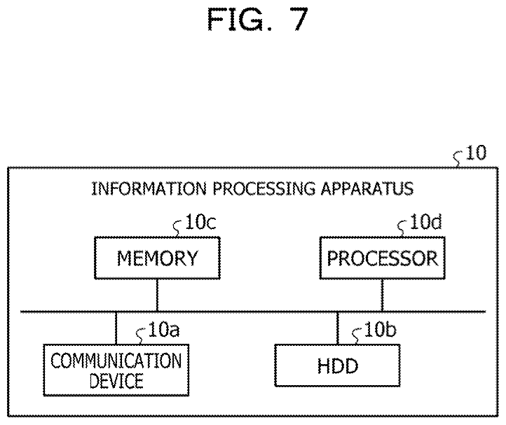

An example of a hardware configuration of the information processing apparatus 10 is described. FIG. 7 is a diagram illustrating an example of a hardware configuration. As illustrated in FIG. 7, the information processing apparatus 10 includes a communication device 10a, a hard disk drive (HDD) 10b, a memory 10c, and a processor 10d. The components illustrated in FIG. 7 are coupled to each other by a bus or the like.

The communication device 10a is a network interface card or the like and communicates with another server. The HDD 10b stores programs that causes the functions illustrated in FIG. 4 to operate and a database (DB).

The processor 10d reads from the HDD 10b or the like the programs that perform processing similar to the processing performed by the processing units illustrated in FIG. 4 and loads the read programs on the memory 10c, thereby a process that performs the functions illustrated in, for example, FIG. 4 is operated. For example, this process performs the functions similar to the functions of the processing units included in the information processing apparatus 10. For example, the processor 10d reads programs having the similar functions to those of, for example, the approximation processing unit 21 and the integerization processing unit 22 from the HDD 10b or the like. Then, the processor 10d performs the process that performs the same processing as the processing of, for example, the approximation processing unit 21 and the integerization processing unit 22.

As described above, the information processing apparatus 10 is operated as an information processing apparatus that performs the method of processing information by reading and executing the programs. The information processing apparatus 10 may also realize the similar functions to those of the above-described embodiment by reading programs from a recording medium with a medium reading device and executing the read programs. The programs described for another embodiment are not limited to the programs to be executed by the information processing apparatus 10. For example, the present invention may be similarly applied to the case where another computer or server executes the programs or the case where the other computer and server cooperate with each other to execute the programs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a processor included in a computer to execute a process, the process comprising:
calculating, by using a tolerance being predetermined and information on a Hamiltonian, a half adjust position with which an error of the Hamiltonian between a numerical value of the Hamiltonian before approximation of the Hamiltonian and a numerical value of the Hamiltonian after the approximation of the Hamiltonian is smaller than or equal to the tolerance; and
performing integerization on the numerical value of the Hamiltonian based on the half adjust position.

2. The non-transitory computer-readable storage medium according to claim 1, the process further comprising:
identifying a half adjust position of a smaller value among a half adjust position set in accordance with a restricting condition of a calculation device to which the integerized Hamiltonian is input and the half adjust position calculated by using the tolerance and the information on the Hamiltonian, wherein
the calculating includes converting, by performing half adjust on an approximate value of the numerical value of the Hamiltonian at the half adjust position of the smaller value, the approximate value into an integer.

3. The non-transitory computer-readable storage medium according to claim 1, the process further comprising:
identifying a half adjust position of a smaller value among a maximum value of a half adjust position in accordance with a restricting condition of a calculation device to which the integerized Hamiltonian is input and the half adjust position calculated by using the tolerance and the information on the Hamiltonian, wherein
the calculating includes converting, by performing half adjust on an approximate value of the numerical value of the Hamiltonian at the half adjust position of the smaller value, the approximate value into an integer.

4. An information processing method comprising:
calculating, by using a tolerance being predetermined and information on a Hamiltonian, a half adjust position with which an error of the Hamiltonian between a numerical value of the Hamiltonian before approximation of the Hamiltonian and a numerical value of the Hamiltonian after the approximation of the Hamiltonian is smaller than or equal to the tolerance; and
performing integerization on the numerical value of the Hamiltonian based on the half adjust position.

5. The information processing method according to claim 4, further comprising:
identifying a half adjust position of a smaller value among a half adjust position set in accordance with a restricting condition of a calculation device to which the integerized Hamiltonian is input and the half adjust position calculated by using the tolerance and the information on the Hamiltonian, wherein
the calculating includes converting, by performing half adjust on an approximate value of the numerical value of the Hamiltonian at the half adjust position of the smaller value, the approximate value into an integer.

6. The information processing method according to claim 4, further comprising:
identifying a half adjust position of a smaller value among a maximum value of a half adjust position in accordance with a restricting condition of a calculation device to which the integerized Hamiltonian is input and the half adjust position calculated by using the tolerance and the information on the Hamiltonian, wherein
the calculating includes converting, by performing half adjust on an approximate value of the numerical value of the Hamiltonian at the half adjust position of the smaller value, the approximate value into an integer.

7. An information processing apparatus comprising:
a memory; and
a processor coupled to memory and configured to:
calculate, by using a tolerance being predetermined and information on a Hamiltonian, a half adjust position with which an error of the Hamiltonian between a numerical value of the Hamiltonian before approximation of the Hamiltonian and a numerical value of the Hamiltonian after the approximation of the Hamiltonian is smaller than or equal to the tolerance, and
perform integerization on the numerical value of the Hamiltonian based on the half adjust position.

8. The information processing apparatus according to claim 7, wherein the processor is further configured to:
identify a half adjust position of a smaller value among a half adjust position set in accordance with a restricting condition of a calculation device to which the integerized Hamiltonian is input and the half adjust position calculated by using the tolerance and the information on the Hamiltonian, and
convert, by performing half adjust on an approximate value of the numerical value of the Hamiltonian at the half adjust position of the smaller value, the approximate value into an integer.

9. The information processing apparatus according to claim 7, wherein the processor is further configured to:
identify a half adjust position of a smaller value among a maximum value of a half adjust position in accordance with a restricting condition of a calculation device to which the integerized Hamiltonian is input and the half adjust position calculated by using the tolerance and the information on the Hamiltonian, and
convert, by performing half adjust on an approximate value of the numerical value of the Hamiltonian at the half adjust position of the smaller value, the approximate value into an integer.
